(19) United States
(12) Patent Application Publication
(10) Pub. No.: US 2008/0135348 A1
(43) Pub. Date: Jun. 12, 2008

(54) Internal brake caliper assembly

(76) Inventors: David B. Drennen, Bellbrook, OH (US); Ernest Ray Siler, Springboro, OH (US); Paul Rymoff, Bellbrook, OH (US)

Correspondence Address: DELPHI TECHNOLOGIES, INC., M/C 480-410-202, PO BOX 5052, TROY, MI, 48007, US

(21) Appl. No.: 11/636,160

(22) Filed: Dec. 8, 2006

(51) Int. Cl. F16D 55/04

(52) U.S. Cl. 188/71.3

(57) ABSTRACT

A brake caliper assembly includes opposing brake shoes positioned on substantially opposing inner surfaces of a dual-disk rotor, wherein said assembly comprises an internal actuator circumferentially arranged between radially inner and outer portions of the rotor, the actuator having an inner surface facing an inboard rotor inner surface and an outer surface facing an outboard rotor inner surface; a plurality of pistons integral to the actuator and displaceable therein by pressurized fluid supplied to the actuator; a first brake shoe mounted to the actuator inner surface and displaceable by the plurality of pistons to engage the inboard rotor inner surface; a pair of pins mounted on the actuator to slide for purposes of transferring a reactionary load; and a second brake shoe mounted to the actuator outer surface and driven by the reactionary load into the outboard rotor inner surface.

### BACKGROUND

The disclosure is directed generally to a hydraulic brake caliper assembly, and more particularly to a hydraulic brake caliper assembly being circumferentially located between a dual-disk rotor including brake pads internally applied on the dual-disk rotor.

Automotive vehicle wheel disc brakes rely upon the friction of opposing brake pads gripping a rotor to slow a vehicle such as a car or truck. Conventional brake caliper assemblies cause the brake pads located on opposite sides of a single rotor to apply a braking force against the rotor to generate a braking torque. A piston is supported by the brake caliper assembly and is in contact with the inner brake pad. A stationary member (i.e., caliper bridge) of the brake caliper assembly is positioned proximate to but does not contact the rotor and holds the pads. The caliper bridge thickness is limited by the wheel inside diameter. The stationary member further includes a forward bridge and a rear bridge that each span the outer circumference of the rotor from inboard to outboard. During braking, the inner brake pad is forced against the rotor and a resulting reactionary force pulls the outer brake pad into engagement with the opposite side of the rotor.

In order to determine the maximum deflection of a pad support structure (i.e., bridge deflection or rotor deflection) and the corresponding brake fluid displacement, a variety of finite element analysis computer dynamic models of hydraulic brake systems simulating different caliper geometry (i.e., externally applied on a single-disk rotor or internally applied on a dual-disk rotor) having a fixed clamping force as an input are created. Elimination of the caliper bridge geometry and its associated deflection, as well as dual-disk rotor deflection management, provides opportunities to enhance a wide range of system parameters such as increased brake pedal stiffness, decreased brake fluid displacement and decreased brake apply pressure.

### SUMMARY

According to one aspect, a brake caliper assembly includes opposing brake shoes positioned on substantially opposing inner surfaces of a dual-disk rotor, wherein said assembly comprises an internal actuator circumferentially arranged between radially inner and outer portions of the rotor, the actuator having an inner surface facing the inboard rotor inner surface, and an outer surface facing the outboard rotor inner surface; a plurality of pistons integral to the actuator displaceable by pressurized fluid supplied to the actuator; a first brake shoe mounted to the actuator inner surface and displaceable by the pistons into the inboard rotor inner surface; a pair of pins mounted on the actuator allowing the actuator to slide for purposes of transferring a reactionary load; and a second brake shoe mounted to the actuator outer surface and driven by the reactionary load into the outboard rotor inner surface.

In another aspect, the brake caliper assembly also includes apparatus for reducing the rotor displacement.

In another aspect, the brake caliper assembly also includes apparatus for transmitting increasing braking force torque to the rotor, as well as transmitting increasing braking force torque to an associated vehicle axle.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a front perspective, inboard view of one aspect of the disclosed internal brake caliper assembly;

FIG. 2 is a front perspective view of an internal actuator assembly for the internal brake caliper assembly shown in FIG. 1;

FIG. 3 is a front perspective view of a brake shoe and lining assembly mounted onto the internal actuator assembly of FIG. 2;

FIG. 4 is a rear perspective view of the brake shoe and lining assembly of FIG. 3;

FIG. 5 is a front perspective, inboard view of the internal brake caliper assembly of FIG. 1;

FIG. 6 is a front perspective, inboard view of the dual rotor assembly of FIG. 5;

FIG. 7 is a front perspective, inboard view of the internal actuator circumferentially located between the dual-disk rotor of the internal brake caliper assembly of FIG. 5;

FIG. 8 is a front perspective view of the internal brake caliper assembly of FIG. 5, shown without the dual rotor assembly;

FIG. 9 is an illustration calculated by finite element analysis showing the maximum Von Mises stress for one aspect of the disclosed internal brake caliper assembly;

FIG. 10 is an illustration calculated by finite element analysis showing the maximum displacement between the rotors for one aspect of the disclosed internal brake caliper assembly;

FIG. 11 is an illustration calculated by finite element analysis showing the maximum Von Mises stress for a conventional hydraulic brake caliper; and

FIG. 12 is an illustration calculated by finite element analysis showing the maximum displacement of the caliper bridge for a conventional hydraulic brake caliper.

### DETAILED DESCRIPTION

As shown in FIG. 1, a brake caliper assembly, generally denoted 10, may include a central mounting face 12 for mounting the assembly 10 on an associated vehicle drive member (not shown), such as a spindle or vehicle axle. The mounting face 12 may be provided with a central pilot aperture 14 in which the spindle hub or the like may be closely received and a plurality of circumferentially spaced-apart fastener apertures 16 in which fasteners (not shown) may be received to mount the assembly 10 on an associated drive mechanism (not shown) in a conventional manner. The brake caliper assembly 10 further includes a peripheral section (also referred to as a dual rotor), generally denoted 20, an actuator assembly, generally denoted 30, and a shoe and lining assembly, generally denoted 40.

As illustrated in FIG. 6, the dual rotor 20 may include a pair of annular braking plates including an outboard braking plate 22 and an inboard braking plate 24, disposed in a spaced-apart relationship. The dual rotor 20 further includes a central hub 29 disposed in an axial direction between the braking plates 22, 24 and through which the vehicle axle (not shown) may be closely received. The first braking plate 22 preferably extends radially from the central mounting face 12. The outboard and inboard braking plates 22, 24 have substantially the same radial dimension and thickness, although alternatively, the braking plates may be of a different radial and/or thickness dimensions.

As shown in FIG. 6, each braking plate 22, 24 has a respective inner surface 21, 23. The inner surfaces 21, 23 may face each other. Braking plates 22, 24 may include outer surfaces 25, 26, respectively. A flat, annular braking surface 27 may be disposed on the inner surface 21 of the first braking plate 22, and a flat, annular braking surface 28 may be disposed on the inner surface 23 of the second braking plate 24. The braking surfaces 21, 23 may be disposed in a parallel relationship for contact with the brake pads (not shown).

The tangential direction of the resulting compressive clamping or braking force onto the inner braking surfaces 27, 28 of the braking plates 22, 24, respectively is shown by the arrow F, as illustrated in FIG. 8. Likewise, the radial distance from the central pilot aperture 14 to the braking surfaces 27, 28 is shown by the arrow R, as illustrated in FIG. 8. It is well known to those skilled in the art, that braking torque is the product of the resulting compressive clamping force and the radial distance, and consequently, the torque may be increased by an increase in the force, by an increase in the radial distance, or combinations thereof.

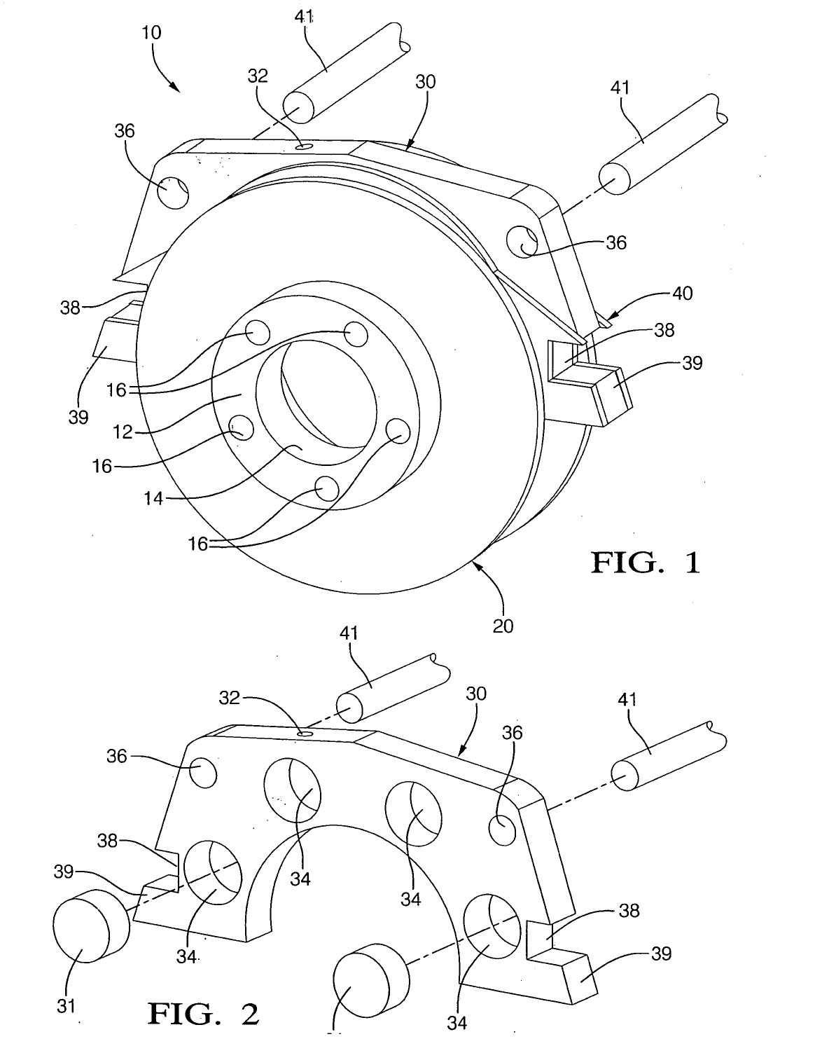

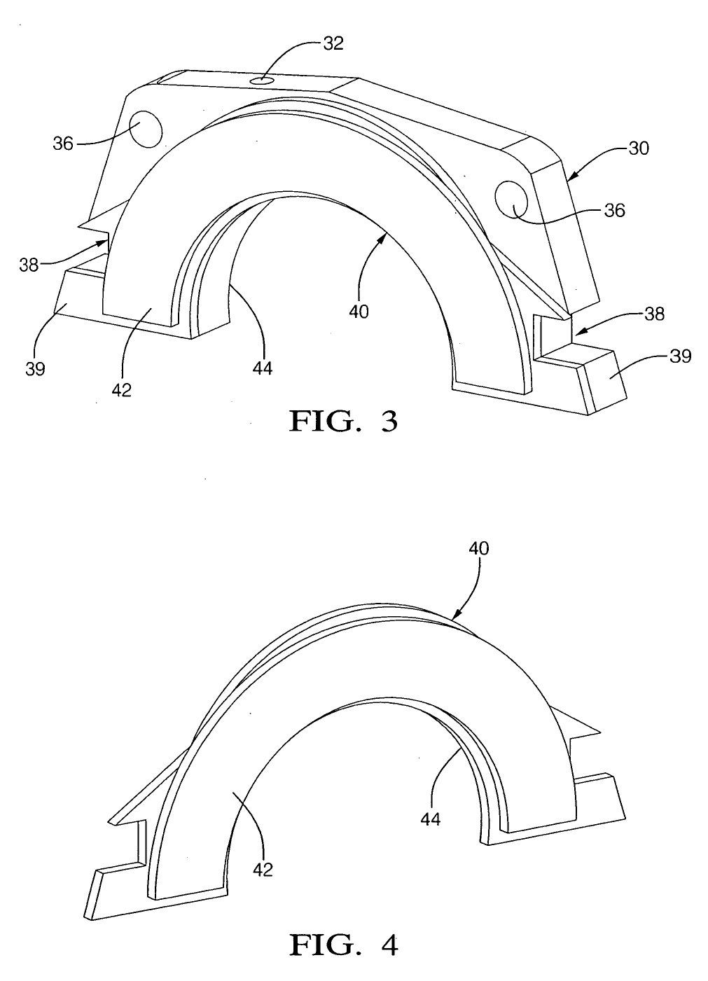

As illustrated in FIG. 2, an actuator 30 includes a pair of notches 38 located in the radially extending side walls of the actuator below a pair of pin bores 36, where each side wall contains a single notch 38 and a single pin bore 36. A plurality of piston assemblies 31 (see FIG. 2) may be received in the plurality of piston cylinder bores 34. A single hydraulic opening 32 is provided for the piston bores 34 and is located on the uppermost surface of the actuator assembly 30. Alternatively, two hydraulic openings may be provided, one for bleeding purposes and the other for connection to a source of brake fluid actuating pressure such as a master cylinder (not shown). The brake fluid actuating pressure will drive the multiple pistons (not shown) into the outer braking pad 42 (see FIGS. 3 and 4) which is driven into an inner braking surface 27 of the outboard braking plate 22.

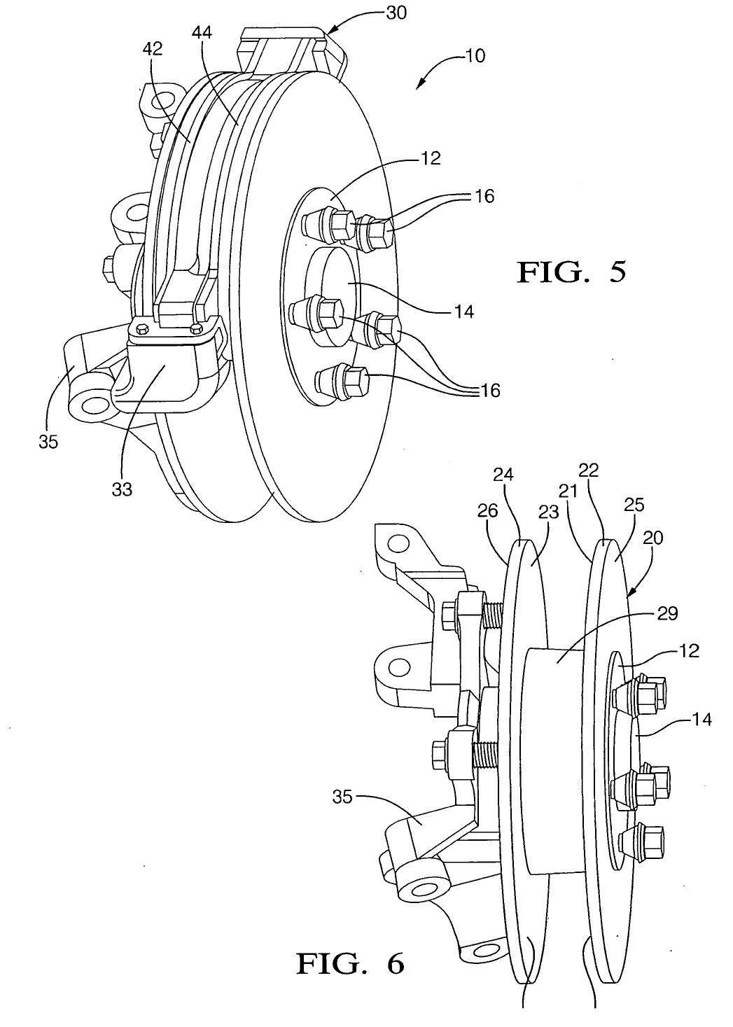

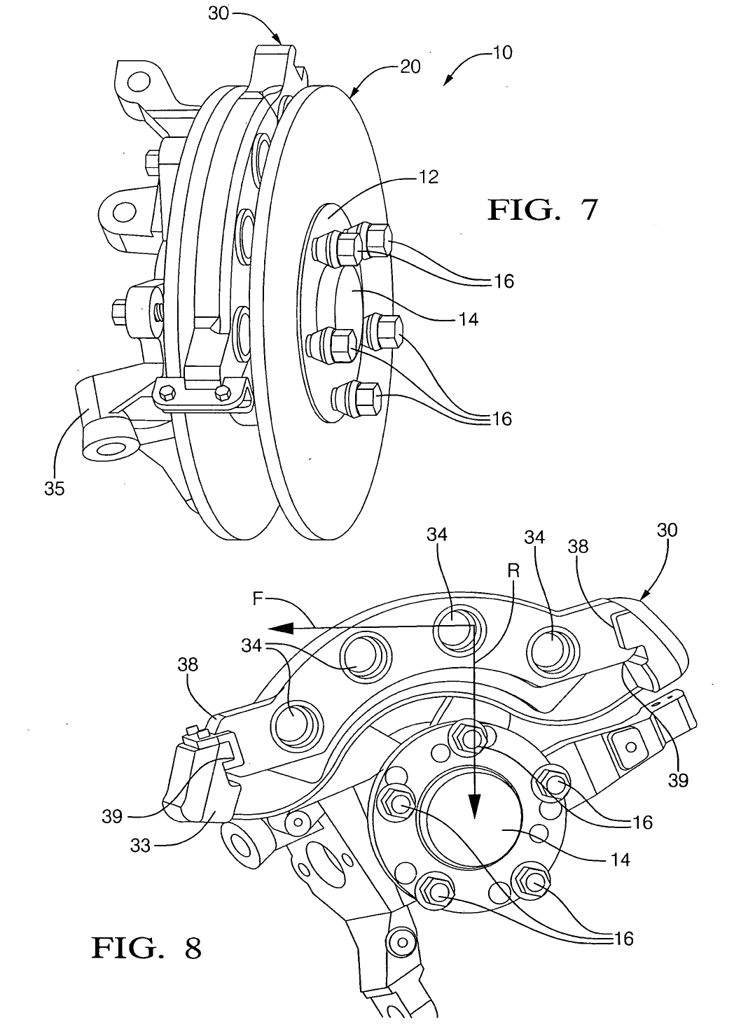

As shown in FIG. 4, the actuator 30 (FIG. 3) includes a shoe and lining assembly 40 having a pair of outer braking surfaces 42, 44 oriented facing the braking surfaces disposed on the inner surfaces 27, 28, respectively (see FIG. 6). As shown in FIG. 3, notches 38 and base portions 39 immediately below the notches on the actuator 30 have two functions. First, the notches 38 receive pins 41 (see FIG. 1) that allow the actuator 30 to slide in order to transfer the reactionary loads to the opposite inner disk surface 28. Second, once the pads 42, 44 are in full contact with both inside disk surfaces 27, 28 the braking torque is transferred through the notches 38 to the caliper bracket 33 (see FIG. 5) to the knuckle 35, and to an associated vehicle axle (not shown). The base portions 39 support the caliper bracket 33 and generally retard circumferential deflection by the caliper bracket 33 from the forces associated with the braking torque. It should be noted that the steering knuckle 35 is the pivot point of the steering system. On vehicles with conventional suspension systems, the spindle of steering knuckle 35 locates and supports the inner and outer wheel bearings (not shown).

With the embodiments described, the resulting clamping force applied to the dual rotor braking plates 22, 24 will only result in a small deflection of the dual rotor braking plates 22, 24, compared to a conventional hydraulic caliper where there is substantial caliper bridge deflection. Both outer rotor surfaces 25, 26 (see FIG. 6) are exposed directly and entirely to ambient airflow resulting in an increased heat dissipation. The outer rotor 25, 26 surface area available for convective heat transfer may be about twice the single-rotor surface area typically used with conventional brakes. The dual rotor assembly 20 preferably may be cast as a unitary, one-piece rotor, although separate components may be cast and assembled to achieve the finished dual rotor assembly 20.

With the embodiments of this disclosure, the need for a caliper bridge may be eliminated, which provides increased brake pedal stiffness and reduced brake response time. Further advantages include an increase in available rotor surface area inside the rotor to increase heat dissipation as well as allow adequate space for multiple pistons. Use of multiple pistons with smaller diameters will generate more braking torque but should also be more responsive (i.e., reduced brake response time) due to the elimination of bridge deflection. The multiple pistons preferably are spaced around the dual disk rotor 20 to increase brake shoe surface area, thereby reducing shoe wear and applying force to the rotor uniformly to reduce shoe taper wear. The specific number of pistons selected for implementation into the actuator assembly 30 can be variable and application dependent.

During braking, actuator assembly 30 sandwiched between braking plates 22, 24, urges the piston head against the back of the brake shoe and lining assembly 40, in particular the inner brake shoe 42, and urges the friction material of the shoe against the braking surface 27 of the outboard braking plate 22. The reactionary force on the actuator assembly 30 causes the actuator to slide on pins 41 within a channel formed by the region comprising the notches 38 and the caliper bracket 33 which forces the outer brake shoe 44 into the inner brake surface 28 of the inboard braking plate 24, thereby generating a clamping force or braking force against the braking plates 22, 24 which acts to slow the driven vehicle.

Conversely, upon release of the brake pedal, the brake shoe and lining assembly 40 are pulled away from the braking plates 22, 24 by opposite action of the actuator assembly 30, creating a clearance between the braking plates 22, 24 and the actuator assembly 30 sandwiched therebetween, thereby significantly reducing, if not altogether eliminating brake drag. Provision of such a clearance between the actuator assembly 30 and the braking plates 22, 24 as well as the degree of clearance created, is understood to be dependent on rotor braking plate 22, 24 run out and acceptable predetermined parameters of braking plates 22, 24 to brake shoe 42, 44 clearance. In conventional hydraulic brake assemblies, a hydraulic seal around an actuating piston thereof is designed to retract the piston from the rotor somewhat, with retraction being dependent on parameters known by those skilled in the art.

The following non-limiting examples enable certain aspects of the disclosure to be more clearly understood. Other examples are left to the artisan.

### EXAMPLE 1

### Conventional Hydraulic Brake System

A conventional hydraulic brake system (not shown) was tested in simulation using a validated vehicle simulation model. U.S. Pat. No. 6,668,983 to Drennen et al., discloses the operation and assembly of a conventional hydraulic brake caliper having opposing brake pads positioned on opposite sides of a rotor and is incorporated herein by reference. The tests included a simulated 7,000 lb. clamping force placed on both sides of a single rotor by a conventional caliper assembly. The finite element analysis results were presented as Von Mises stress, and maximum displacement. The Von Mises stress is a useful quantitative measurement of tensile loading for a material of construction. As the artisan well knows, a lower tensile loading placed on the rotor material enhances the ability of the rotor material to transmit braking force torque applied by the brake calipers through the caliper assembly and to the vehicle axle. The inside diameter of the wheel is disposed directly above the caliper bridge, thereby limiting the allowable bridge thickness and consequently, the allowable dimensions for the caliper assembly. It is well known by those in the art, that a thinner bridge significantly increases the maximum displacement of the bridge, and conversely, reduces the stiffness of the brake pedal. Said another way, brake pedal stiffness may be characterized as a low displacement in a braking system. A low displacement is highly desirable in a brake system, as less displacement translates into a shorter response time for the braking system. As the piston and piston bore is a component of the caliper assembly, the piston bore size is limited for the same reasons as the bridge thickness detailed above.

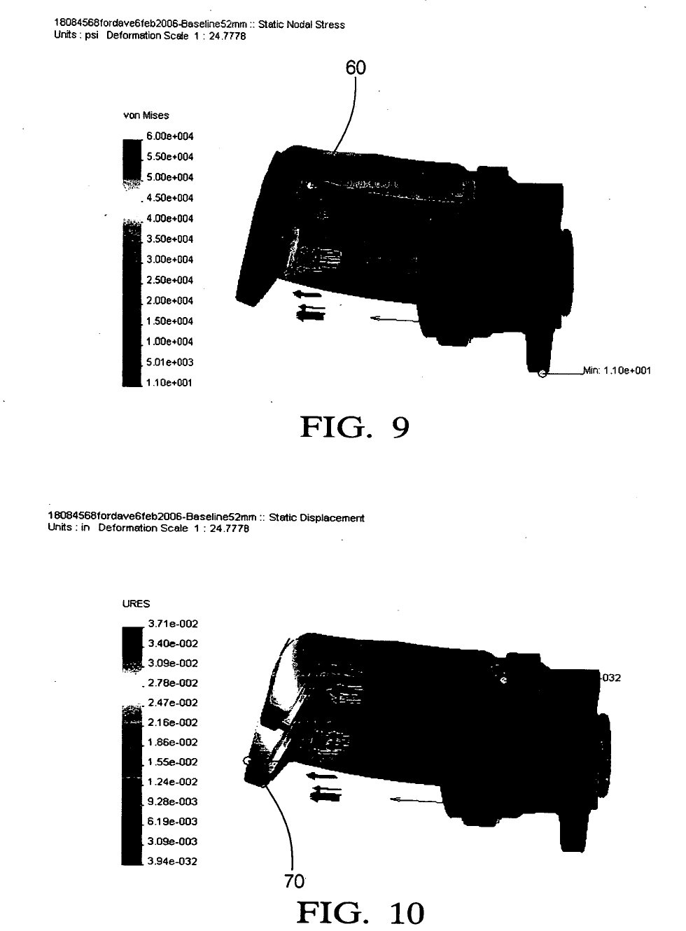

In Example 1, one piston element having a bore diameter of 52 mm and operating with a 2,000 psi hydraulic pressure generated a 0.037 inch displacement in the caliper bridge, as illustrated in FIG. 10 at point 70. Said another way, for the piston to move 0.037 inches requires 111 mm³ hydraulic fluid displacement from the master cylinder, which results in a delayed response time for the conventional hydraulic braking system. The Von Mises stress result was 60,000 psi, as illustrated in FIG. 9 at point 60.

### EXAMPLE 2

### Internal Brake Caliper Assembly

An internal brake caliper assembly (shown in FIG. 1) was tested in simulation using the validated vehicle simulation model, as in Example 1. The tests included a simulated 7,000 lb. clamping force placed on the inner surfaces of a dual rotor by an internal caliper assembly. The finite element analysis results were presented as Von Mises stress, and maximum displacement. The internal brake caliper assembly did not include a caliper bridge and consequently did not suffer from the thickness limitations of said bridge. Furthermore, the pistons and pistons bores are components of the actuator assembly, and consequently do not suffer from the piston bore size limitations of the caliper assembly of Example 1.

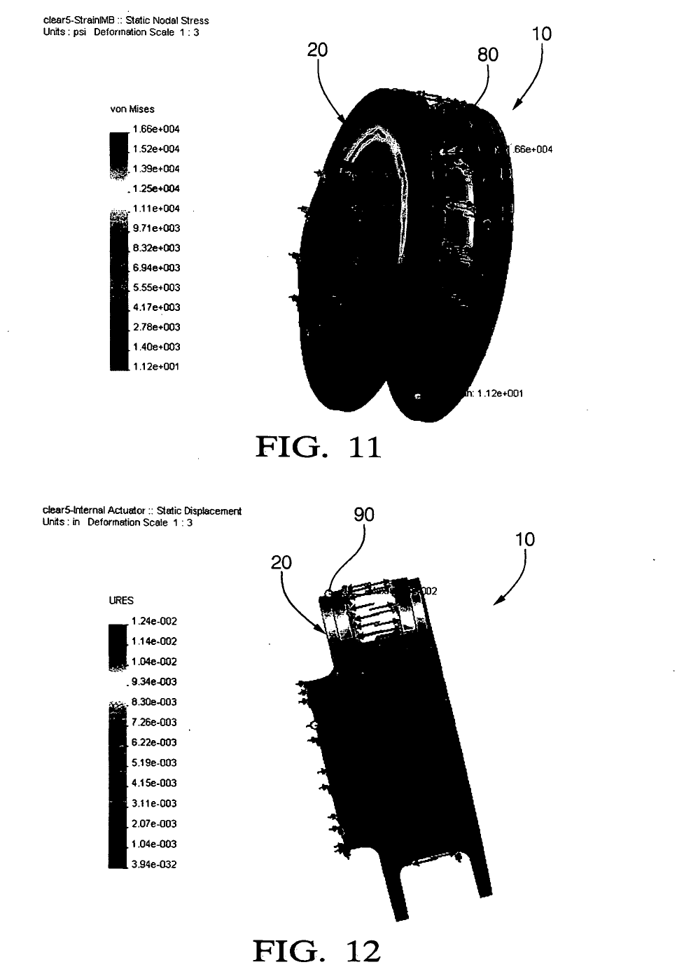

In Example 2, four piston elements, each having a bore diameter of 38 mm and operating with a 1,000 psi hydraulic pressure generated a 0.012 inch displacement in the rotor braking plates (i.e., rotor coning), as illustrated in FIG. 12 at point 90. Said another way, for the pistons to move 0.012 inches requires 54 mm³ hydraulic fluid displacement from the master cylinder, which results in approximately one-half the delayed response time for the internal brake caliper assembly, as compared to Example 1. The Von Mises stress result was 16,000 psi, as illustrated in FIG. 11 at point 80, which enables the internal brake caliper assembly to transmit an additional 44,000 psi of braking torque, as compared to Example 1.

Having described the disclosure in detail and by reference to specific embodiments thereof, it will be apparent that numerous variations and modifications are possible without departing from the spirit and scope of the disclosure as defined by the following claims.

What is claimed is:

1. A brake caliper assembly includes opposing brake shoes positioned on substantially opposing inner surfaces of a dual-disk rotor, wherein said assembly comprises:
a) an internal actuator circumferentially arranged between radially inner and outer portions of said rotor, said actuator having an inner surface facing an inboard rotor inner surface and an outer surface facing an outboard rotor inner surface;
b) a plurality of pistons integral to said actuator and displaceable therein by pressurized fluid supplied to said actuator;
c) a first brake shoe mounted to said actuator inner surface and displaceable by said plurality of pistons to engage the inboard rotor inner surface;
d) a pair of pins mounted on said actuator to slide for purposes of transferring a reactionary load; and
e) a second brake shoe mounted to said actuator outer surface and driven by said reactionary load into the outboard rotor inner surface.

2. The brake caliper assembly of claim 1, wherein said actuator includes a pair of notches located in the radially extending side walls of said actuator below said pins, wherein each side wall contains a single notch, and a single pin.

3. The brake caliper assembly of claim 2, wherein said actuator further comprises a caliper bracket mounted to said actuator at said notch, wherein each caliper bracket is mounted to steering knuckle, and said knuckle is mounted to an associated vehicle axle.

4. A brake caliper assembly of claim 3, further comprising a means for reducing the rotor displacement.

5. The brake caliper assembly of claim 4, wherein said means for reducing the rotor displacement is provided by circumferentially internally wrapping said plurality of pistons around the dual disk rotor in order to apply the necessary braking force to the rotor most uniformly thereby reducing the rotor displacement.

6. A brake caliper assembly of claim 5, further comprising a means for transmitting increasing braking force torque to said dual-disk rotor.

7. The brake caliper assembly of claim 6, wherein said means for transmitting increasing braking force torque to said dual-disk rotor is provided by circumferentially internally wrapping said plurality of pistons around the dual disk rotor in order to increase the contacting brake shoe surface area and thereby increase resulting brake force torque applied to said rotor.

8. A brake caliper assembly of claim 7, further comprising a means for transmitting increasing braking force torque to an associated vehicle axle.

9. The brake caliper assembly of claim 6, wherein said means for transmitting increasing braking force torque to an associated vehicle axle is provided by enhancing the ability of the rotor to transmit increasing braking force torque applied through the notch to the caliper bracket and to an associated vehicle axle.
